(19) United States
(12) Patent Application Publication
(10) Pub. No.: US 2005/0170052 A1
(43) Pub. Date: Aug. 4, 2005

(54) Water and feed preservative for animal uses

(76) Inventor: Julio Lionel Pimentel, Buford, GA (US)

Correspondence Address: JULIO L. PIMENTEL, 3206 WINDGATE DR, BUFORD, GA, 30519-1941, US

(21) Appl. No.: 10/768,631

(22) Filed: Feb. 2, 2004

(51) Int. Cl. C12H 1/10

(52) U.S. Cl. 426/321

(57) ABSTRACT

Composition and methods for preservation of water, feed and major feed ingredients for animal uses. A composition comprising a terpene mixture, is disclosed. The composition can be a true solution of an effective amount of effective terpene (s) and a surfactant. The composition can be a suspension or emulsion comprising of terpene (s), surfactant, and water. The composition(s) of the invention can be administered as a spray mist over feed while mixing, drop-wise as in a medicator (dosificator) in water or mix as a component of the diet. A true solution of terpene and water can be formed by mixing terpene and water at a solution-forming shear rate in the absence of a surfactant. A suspension of terpene and water can be formed by mixing terpene and water at a solution-forming shear rate in the presence of a surfactant.

### BAKGROUND OF THE INVENTION

1. Field of the Invention

A method to extend the shelf-life of water, feed and major feed ingredient by spray-treating or by adding to such water, feed and major feed ingredient a composition containing citral, eugenol, 1-carvone and surfactant with or without water.

2. Discussion of the Background

Many products have been developed for the preservation of water and feed for animal uses. Water additives i.e. ammonium quaternary products, chlorite-based products, chlorination, chlorine dioxide and acids compounds (acetic, sorbate, ascorbic, citric, formic) have been effective to some extend but they become ineffective or neutralized when in contact with organic matter. Methods for preservation of feed include organic acids and formaldehyde. Alternative products that are safe and effective are always been sought.

A contaminated water, feed and major feed ingredients can produce digestive tract infections, which are caused by pathogenic, and opportunistic microorganisms and toxins produced by them. These illnesses are present in all types of animals and humans. Traveler's diarrhea in humans may be presented either as (1) acute watery diarrhea (2) diarrhea with blood (dysentery) or (3) chronic diarrhea, often with clinical nutrient malabsorption. The common pathogens that produce traveler's diarrhea include Clostridium difficile, Yersenia enterolitica, Shigella sp., Campylobacter sp., Salmonella sp., ETEC (enterotoxigenic) and EAEC (enteroaggregative) Escherichia coli. Viruses such as rotavirus, cytomegalovirus and Norwalk agent are less common causes. The use of antibiotics limits the course of diarrhea to a little over a day compared with an average of over 3-5 days when diarrhea remains untreated. The extensive use of antibiotics can also lead to overgrowth syndromes like Candida vaginitis and Clostridium difficile due to less competitive environment in the gastrointestinal tract.

In animals, the presence of scours in calves and piglets is of economic importance. Most of the mortality and morbidity of the calves are due to infectious diseases. More than 90% of scours in calves is produced by E. coli and Salmonella & Clostridia. There are preventive methods like (1) vaccination of the mothers in order to passively transfer antibodies in colostrum; (2) the use of immunological supplements for milk replacers; (3) the use of probiotics to create a gastro-intestinal healthy environment and (4) changes in husbandry. None of these protective measures are 100% effective.

The incidence of diarrhea in neonates and weaned piglets is also very high. Again, E. coli and Salmonella are the main microorganisms involved in diarrhea in swine. One of the preferred methods to prevent this problem is segregated early weaning (SEW). The basis of early weaning is that the earlier piglets are weaned from the sow less are the chances of crossover diseases between sow and piglets. In both cases, calf and piglet scours, the preferred method of treatment is antibiotics. The European Community has banned the use of 5 antibiotics and in the Unites States the FDA is banning the use of fluoroquinolone in animals due to the development of Campylobacter resistant to this antibiotic. Bacteria resistance has encouraged the development of antibiotic-alternative products.

Terpenes, which are Generally Recognized as Safe (GRAS), are widespread in nature, mainly in plants as constituents of essential oils. Their building block is the hydrocarbon isoprene (C₅H₈)ₙ. Examples of terpenes include citral, pinene, nerol, b-ionone, geraniol, carvacrol, eugenol, carvone, terpeniol, anethole, camphor, menthol, limonene, nerolidol, farnesol, phytol, carotene, squalene, thymol, tocotrienol, perillyl alcohol, bomeol, myrcene, simene, carene, terpenene, linalool and others. Geraniol, tocotrienol, perillyl alcohol, b-ionone and d-limonene, suppress hepatic HMG-COA reductase activity, a rate-limiting step in cholesterol synthesis, and modestly lower cholesterol levels in animals (Elson C. E. and S. G. Yu, 1994, The Chemoprevention of Cancer by Mevalonate-Derived Constituents of Fruits and Vegetables, J. Nutr. 124: 607-614). D-limonene and geraniol reduced mammary tumors (Elgebede, J. A., C. E. Elson, A. Qureshi, M. A. Tanner and M. N. Gould, 1984, Inhibition of DMBA-Induced Mammary Cancer by Monoterpene D-limonene, Carcinogensis 5(5): 661-664; Elgebede, J. A., C. E. Elson, A. Qureshi, M. A. Tanner and M. N. Gould, 1986, Regression of Rat Primary Mammary Tumors Following Dietary D-limonene, J. Nat'l Cancer Institute 76(2): 323-325; Karlson, J., A. K. Borg, R. Unelius, M. C. Shoshan, N. Wilking, U. Ringborg and S. Linder, 1996, Inhibition of Tumor Cell Growth By Monoterpenes In Vitro: Evidence of a Ras-Independent Mechanism of Action, Anticancer Drugs 7(4): 422-429) and suppressed the growth of transplanted tumors (Yu, S. G., P. J. Anderson and C. E. Elson, 1995, The Efficacy of B-ionone in the Chemoprevention of Rat Mammary Carcinogensis, J. Agri. Food Chem. 43: 2144-2147).

Terpenes have also been found to inhibit the in vitro growth of bacteria and fungi (Chaumont J. P. and D. Leger, 1992, Campaign Against Allergic Moulds in Dwellings, Inhibitor Properties of Essential Oil Geranium “Bourbon,” Citronellol, Geraniol and Citral, Ann. Pharm. Fr 50(3): 156-166), and some internal and external parasites (Hooser, S. B., V. R. Beasly and J. J. Everitt, 1986, Effects of an Insecticidal Dip Containing D-limonene in the Cat, J. Am. Vet. Med. Assoc. 189(8): 905-908). Geraniol was found to inhibit growth of Candida albicans and Saccharomyces cerevisiae strains by enhancing the rate of potassium leakage and disrupting membrane fluidity (Bard, M., M. R. Albert, N. Gupta, C. J. Guuynn and W. Stillwell, 1988, Geraniol Interferes with Membrane Functions in Strains of Candida and Saccharomyces, Lipids 23(6): 534-538). B-ionone has antifungal activity which was determined by inhibition of spore germination and growth inhibition in agar (Mikhlin E. D., V. P. Radina, A. A. Dmitrossky, L. P. Blinkova, and L. G. Button, 1983, Antifungal and Antimicrobial Activity of Some Derivatives of Beta-Ionone and Vitamin A, Prikl Biokhim Mikrobiol, 19: 795-803; Salt, S. D., S. Tuzun and J. Kuc, 1986, Effects of B-ionone and Abscisic Acid on the Growth of Tobacco and Resistance to Blue Mold, Mimicry the Effects of Stem Infection by Peronospora Tabacina, Adam Physiol. Molec. Plant Path 28: 287-297). Teprenone (geranylgeranylacetone) has an antibacterial effect on H. pylori (Ishii, E., 1993, Antibacterial Activity of Terprenone, a Non Water-Soluble Antiulcer Agent, Against Helicobacter Pylori, Int. J. Med. Microbiol. Virol. Parasitol. Infect. Dis. 280(1-2): 239-243). Solutions of 11 different terpenes were effective in inhibiting the growth of pathogenic bacteria in in vitro tests (Kim, J., M. Marshall and C. Wei, 1995, Antibacterial Activity of Some Essential Oil Components Against Five Foodborne Pathogens, J. Agric. Food Chem. 43: 2839-2845). Diterpenes, i.e., trichorabdal A (from R. Trichocarpa), have shown a very strong antibacterial effect against H. pylori (Kadota, S., P. Basnet, E. Ishii, T. Tamura and T. Namba, 1997, Antibacterial Activity of Trichorabdal A from Rabdosia Trichocarpa Against Helicobacter Pylori, Zentralbl. Bakteriol 287(1): 63-67). Owawunmi, G. O., 1989 (Evaluation of the Antimicrobial Activity of Citral, Letters in Applied Microbiology 9(3): 105-108), showed that growth media with more than 0.01% citral reduced the concentration of E. coli, and at 0.08% there was a bactericidal effect. Barranx, A. M. Barsacq, G. Dufau, and J. P. Lauilhe, 1998, Disinfectant or Antiseptic Composition Comprising at Least One Terpene Alcohol and at Lease One Bactericidal Acidic Surfactant, and Use of Such a Mixture; U.S. Pat. No. 5,673,468, teach a terpene formulation, based on pine oil, used as a disinfectant or antiseptic cleaner. Koga, J. T. Yamauchi, M. Shimura, Y. Ogasawara, N. Ogasawara and J. Suzuki, 1998, Antifungal Terpene Compounds and Process for Producing the Same, U.S. Pat. No. 5,849,956, teaches that a terpene found in rice has antifungal activity. Iyer, L. M., J. R. Scott, and D. F. Whitfield, 1999, Antimicrobial Compositions, U.S. Pat. No. 5,939,050, teaches an oral hygiene antimicrobial product with a combination of 2 or 3 terpenes that showed a synergistic effect.

Several U.S. patents (U.S. Pat. Nos. 5,547,677, 5,549,901, 5,618,840, 5,629,021, 5,662,957, 5,700,679, 5,730,989) teach that certain types of oil-in-water emulsions have antimicrobial, adjuvant, and delivery properties. U.S. Pat. No. 5,906,825 teach us of antimicrobial agents from plant and herbal extracts for use on food-contact surfaces. U.S. Pat. No. 5,591,467 teach us of a formaldehyde-based antimicrobial feed additive which has d-limonene to mask the smell of formaldehyde. All these references and patents do not suggest the use of terpene mixtures or terpene suspensions for the preservation of water, feed and major feed ingredients for animals uses.

### SUMMARY OF THE INVENTION

In accordance with the purpose(s) of this invention, as embodied and broadly described herein, this invention relates to a water, feed and major feed ingredients preservative for animal uses.

The invention is related to the field of anti-infectives. The present invention provides compositions and methods for the preservation of water, feed and major feed ingredients that avoid some drawbacks found in previous methods.

The present invention provides a composition for the preservation of water, feed and major feed ingredients comprising an effective amount of effective terpenes. The composition can be a solution. The composition can be a mixture. The composition can be an emulsion. The composition can further comprise a carrier, e.g., water. The composition can further comprise a surfactant.

The composition may be a solution of terpene and surfactant. The composition may be an oil/water emulsion of terpene, surfactant and water. The terpenes of the composition comprise citral, eugenol and carvone, or mixtures thereof.

The composition is effective against various infective agents including bacteria, viruses, mycoplasmas, and/or fungi present in drinking water, feed and major feed ingredients.

The composition can be made by mixing an effective amount of effective terpenes, and surfactant. The mixing can be done at a solution-forming shear until formation of a true solution of the terpene and surfactant; the solution-forming shear may be by high shear or high pressure blending or agitation.

The invention includes a method for making a terpene-containing composition effective as a preservative comprising mixing a composition comprising a terpene, surfactant and water at a solution-forming shear until an oil/water emulsion is formed.

Additional advantages will be set forth in part in the description which follows below. The advantages described below will be realized and attained by means of the elements and combinations particularly pointed out in the appended claims. It is to be understood that both the foregoing general description and the following detailed description are exemplary and explanatory only and are not restrictive.

### DESCRIPTION OF THE PREFERRED EMBODIMENTS

Before the present compositions are disclosed and described, it is to be understood that this invention is not limited to specific synthetic methods. It is also to be understood that the terminology used herein is for the purpose of describing particular aspects only and is not intended to be limiting.

In this specification and in the claims which follow, reference will be made to a number of terms which shall be defined to have the following meanings Definitions.

A “volume percent” of a component, unless specifically stated to the contrary, is based on the total volume of the formulation or composition in which the component is included.

An “effective terpene” of the composition can comprise, for example, citral, pinene, nerol, b-ionone, geraniol, carvacrol, eugenol, carvone, terpeniol, anethole, camphor, menthol, limonene, nerolidol, famesol, phytol, carotene, squalene, thymol, tocotrienol, perillyl alcohol, bomeol, myrcene, simene, carene, terpenene, linalool, or mixtures thereof. More specifically, the terpenes can comprise citral, carvone, eugenol, or mixtures thereof.

By the term “effective amount” of a compound is meant such amount capable of performing the function of the compound or property for which an effective amount is expressed, such as a non-toxic but sufficient amount of the compound to provide the desired function, i.e., preservative. Thus an appropriate effective amount may be determined by one of ordinary skill in the art using only routine experimentation

Several formulations can be obtained by utilizing biocidal terpenes without departing from the principle of the present inventions. Formulations can vary not only in the concentration of terpenes but also in the type of surfactant and water concentration used. This invention can be modified in several ways by adding or deleting from the formulation the type of terpene and surfactant. The present invention includes methods of making the compositions and methods of using the compositions.

Composition(s)

The compositions of the present invention comprise isoprenoids. M ore specifically, the compositions of the present invention comprise terpenoids. Even more specifically, the compositions of the present invention comprise terpenes.

The composition can comprise between about 10 ppm and about 10,000 ppm of the terpene, specifically 100, 250, 500, 1000 or 5000 ppm.

A composition of the present invention comprises an effective amount of effective terpenes. Plant extracts or essential oils containing terpenes can be used in the compositions of this invention as well as the more purified terpenes. Terpenes are readily commercially available or can be produced by various methods known in the art, such as solvent extraction or steam extraction/distillation. Natural or synthetic terpenes are expected to be effective in the invention. The method of acquiring the terpene is not critical to the operation of the invention.

The surfactant can be non-ionic, cationic, or anionic. Examples of surfactant include polysorbate 20, polysorbate 80, polysorbate 40, polysorbate 60, polyglyceryl ester, polyglyceryl monooleate, decaglyceryl monocaprylate, propylene glycol dicaprilate, triglycerol monostearate, Tween™ 20, Span™ 20, Span™ 40, Span™ 60, Span™ 80, or mixtures thereof.

The composition can comprise 1 to 100% by volume terpenes and 0 to 99% by volume surfactant. The composition can comprise 1 to 99% by volume terpenes, 0 to 99% by volume surfactant and 0 to 99% water. More specifically the composition can comprise about 0.01% to about 85% terpenes and about 1-15% surfactant.

Specific compositions can include—1000 ppm terpenes in standard 0.9% saline with 20% citral, 35% 1-carvone, 40% eugenol, and 5% Tween™ 80. Concentrations of terpene from 10 to 2000 ppm can be used as effective concentrations in the compositions and methods of the current invention.

Terpenes have a relatively short life span of approximately 28 days once exposed to air. Terpenes will decompose to CO₂ and water. This decomposition or break down of terpenes is an indication of the safety and environmental friendliness of the compositions and methods of the invention.

The terpenes, and surfactants of the invention may be readily purchased or synthesized using techniques generally known to synthetic chemists.

Methods

The invention includes a method of making the composition of the present invention. A method of making a terpene-containing composition that is effective as a preservative comprises adding an effective amount of an effective terpene to a carrier solvent.

The terpenes and carriers are discussed above. The concentration at which each component is present is also discussed above.

The method can further comprise mixing the terpene, surfactant and carrier (e.g., water, saline, or buffer solution). The mixing is under sufficient shear until a solution is formed. Mixing can be done via any of a number of high shear mixers or mixing methods.

The present invention is effective against any of these classifications of infective agents present in water, feed and major feed ingredients, in particular, bacteria, mycoplasmas, virus and fungi. Examples of these infective agents are Staphylococcus aureus, Aspergillius fumigatus, Mycoplasma iowae, Sclerotinta homeocarpa, Rhizoctonia solani, Colletotrichum graminicola, Penicillum sp., Mycoplasma pneumoniae, E. coli, Salmonella sp., Clostridia sp., Campylobacter sp. and others. The compositions and methods of the present invention are effective in preventing many, if not all, of these infections in a great variety of subjects, including humans, other mammals and avians.

The invention includes a method to disinfect water, feed and major feed ingredients. The method comprises administering the composition of the present invention to a subject by feeding such subject a treated water or feed with the present disclosed composition (s).

The composition of this invention can be administered by a variety of means. For example, sprayed onto feed, sprayed onto water, applied to surfaces where water and feed are stored for future uses or consumed daily, added drop wise through a standard medicator or water dosificator, for example in starter, grower and finisher animal houses.

Throughout this application, various publications are referenced. The disclosures of these publications in their entireties are hereby incorporated by reference into this application in order to more fully describe the state of the art to which this invention pertains.

Methods for making specific and exemplary compositions of the present invention are described in detail in the Examples below.

### EXAMPLES

The following examples are put forth so as to provide those of ordinary skill in the art with a complete disclosure of how the compositions claimed herein are made and evaluated, and are intended to be purely exemplary of the invention and are not intended to limit the scope of what the inventor regard as his invention. There are numerous variations and combinations of the compositions and conditions for making or using them, e.g., component concentrations, and other ranges and conditions that can be used to optimize the results obtained from the described compositions.

The following terpene compositions were utilized in some of the examples now disclosed.

TABLE 1
Terpene Compositions

| | Formula Name and Percentage | | | | | | |
|---|---|---|---|---|---|---|---|
| Ingredient | PL | PL-20 | B | FP | FP-20 | IB | IB-20 |
| Citral | 20 | 20 | 10 | 30 | 30 | 70 | 70 |
| L-carvone | 35 | 35 | 50 | 30 | 30 | 10 | 10 |
| Eugenol | 40 | 40 | 30 | 30 | 30 | 0 | 0 |
| B-ionone | 0 | 0 | 0 | 0 | 0 | 10 | 10 |
| Tween 80 ™ | 5 | 0 | 10 | 10 | 0 | 10 | 0 |
| Span 20 ™ | 0 | 5 | 0 | 0 | 10 | 0 | 10 |

### Example 1

### Effect of Several Terpene Compositions on the Destruction of E. coli Biofilms in PVC (Polyvinyl Chloride) Matrix

In a 96 well PVC microwell plate, 100 ul of 1×10⁶ cfu E. coli in nutrient broth was added to all wells and incubated overnight at 35-37° C. in order to develop a biofilm. After incubation the plate was washed four times with distilled water and 100 ul of 1000 ppm terpene composition (table 1) was added and incubated for 1 hour at room temperature. After incubation 25 ul of 1% crystal violet was added to quantified the biofilm formation by dying the bacteria attached to the well's walls. The plate was incubated for 15 minutes, washed four times with water and blot dry. After drying, 200 ul 95% ethanol was added and mixed in order to solubilize the dye. In a new plate, 150 ul from each well was transferred to clean wells and read at 590 nm. Results are expressed as the difference between OD of control as compared to treated samples after correcting for background OD.

TABLE 2
Effect of several terpene compositions on the
destruction of E. coli biofilms

| | O.D. | O.D. | % decrease |
|---|---|---|---|
| Formula | Terpene | Control | in O.D. |
| PL | .205 | .311 | −34 |
| PL-20 | .372 | .524 | −30 |
| IB | .516 | .650 | −21 |
| IB-20 | .463 | .505 | −8 |
| FP | .419 | .557 | −25 |
| FP-20 | .311 | .441 | −25 |

### Example 2

Effect of Several Terpene Compositions on the Prevention of E. coli Biofilms Formation on PVC Matrix

In a 96 well PVC microwell plate, 100 ul of 1×10⁶ cfu E. coli in nutrient broth was added to all wells. To all wells a 50 ul of 1000 ppm terpene compositions (table 1) was added and incubated overnight at 35-37° C. in order to develop a biofilm. After incubation 25 ul of 1% crystal violet was added to quantified the biofilm formation by dying bacteria attached to well's walls. After 15 minutes incubation at room temperature plate was washed 4 times with distilled water and blotted dry. After drying, 200 ul 95% ethanol was added and mixed in order to solubilize the dye. In a new plate, 150 ul from each well was transferred to clean wells and read at 590 nm. Results are expressed as percent reduction in OD as compared to the control after correcting for background OD.

TABLE 3
Effect of several terpene compositions on the
prevention of E. coli biofilms

| | Background | O.D. | O.D. | % |
|---|---|---|---|---|
| Formula | O.D. | Terpene | Control | reduction |
| IB-20 | .050 | .050 | .278 | 100 |
| FP | .050 | .044 | .266 | 100 |
| B | .050 | .048 | .305 | 100 |
| PL | .034 | .038 | .196 | 98 |
| PL-20 | .034 | .041 | .192 | 96 |
| IB | .034 | .040 | .185 | 97 |

### Example 3

### Determination of Best Terpene Composition

100 ul of nutrient broth containing 2.0×10⁶ cfu E. coli/ml was added to 0.9 ml Butterfield buffer and 1.0 ml of 1000 ppm terpene composition. (table 1). After mixing (no incubation time) 100 ul of each mixture was plated on VRBG (Violet Red Bile Glucose) agar and incubated at 37° C. for 18-24 hours. Plates were visually count after incubation.

TABLE 4
Effect of terpene compositions on E. coli

| | | % reduction |
|---|---|---|
| Formula | cfu/ml | from control |
| PL | 1.8 × 10² | 99.9 |
| PL-20 | 2.29 × 10³ | 99.9 |
| FP | 1.67 × 10³ | 99.9 |
| FP-20 | 10 | 99.9 |
| IB | 4.5 × 10³ | 99.9 |
| IB-20 | 2.3 × 10⁴ | 99.0 |
| Control | TNC* | 0 |

*TNC = too numerous to count

### Example 4

### Determination of Best Terpene Composition

100 ul of nutrient broth containing 2.0×10⁶ cfu E. coli/ml was added to 0.9 ml Butterfield buffer and 1.0 ml of 1000 ppm terpene composition (table 1). After mixing (no incubation time) 100 ul of each mixture was plated on VRBG agar and incubated at 37° C. for 18-24 hours. Plates were visually count after incubation.

TABLE 5
Effect of terpene compositions on E. coli

| | | % reduction |
|---|---|---|
| Formula | cfu | from control |
| PL | 1.83 × 10³ | 99.9 |
| PL-20 | 1.26 × 10³ | 99.9 |
| FP | 2.3 × 10² | 99.9 |
| FP-20 | 6.0 × 10³ | 99.9 |
| IB | 2.25 × 10³ | 99.9 |
| IB-20 | 1.5 × 10⁷ | 50.00 |
| Control | 3.0 × 10⁷ | 0 |

### Example 5

### Stability of Citral in Water

A solution containing 1000 ppm citral in distilled water was homogenized with a high speed homogenizer. This solution was stored in a beaker covered with porous paper for a week. The concentration of citral remaining after a week was determined by a gas chromatography. A standard curve was prepared with reagent grade citral to which b-ionone was used as internal standard. At the beginning of the study and after a week the concentration of citral was determined by plotting it on the standard curve.

TABLE 6
Stability of citral in water.

Percentage of
citral remaining

| | Day 1 | Week 1 |
|---|---|---|
| Citral (1000 ppm) | 100 | 21.5% |

### Example 6

### Stability of Citral in Water

A solution containing 1000 ppm citral in distilled water was homogenized with a high speed homogenizer. This solution was stored in a closed glass bottle for four weeks. Concentration of citral remaining was determined by a gas chromatography. A standard curve was prepared with reagent grade citral to which b-ionone was used as internal standard. At the beginning of the study and weekly the concentration of citral was determined by plotting it on the standard curve.

TABLE 7
Stability of citral in water.

Percentage of citral
remaining

| | Day 1 | Week 1 | Week 2 | Week 4 |
|---|---|---|---|---|
| Citral (1000 ppm) | 100 | 32 | 27 | 22 |

### Example 7

### Biocidal Effect of Terpene Compositions in Organic Preservative-Free Apple Juice

To 100 ml of unpasteurized apple juice was added different concentration of terpenes varying from 0 to 250 ppm. After mixing, 0.5 ml of 1×10⁶ cfu E. coli was added to each juice/terpene mixture and incubated at room temperature for a week. After incubation, 0.1 ml of each of the solutions was plated onto nutrient agar and incubated for 18 hours at 37° C. Results are expressed as cfu/ml and percent reduction as compared to control.

TABLE 8
Biocidal effect of terpene compositions in organic
preservative-free apple juice.

| Treatment | cfu/ml | % reduction |
|---|---|---|
| Control | TNC* | 0 |
| 250 ppm B-ionone | 0 | 100 |
| 250 ppm citral | 0 | 100 |
| 125 ppm citral + 125 ppm B-ionone | 10 | 99.0 |

*TNC = too numerous to count

### Example 8

This example shows different oil in water (o/w) emulsions resulting from the terpene composition PL as suggested in table 1. The reason for doing this is to obtain a more user-friendly mixture, easy to apply drop-wise in water or to spray onto feed and food. The preparation was done as follows: water and surfactant were mixed completely until forming a true solution, terpenes were added and homogenize at high speed for 30 seconds in order to form an oil in water emulsion. The formulations are as follows:

TABLE 9
Formulation of oil/water emulsions

Formula Name and
Percentage

| Ingredient | A-70 | A-65 | A-40 | A-45 |
|---|---|---|---|---|
| Citral | 5.00 | 5.00 | 10.00 | 10.00 |
| L-carvone | 8.75 | 8.75 | 17.50 | 17.50 |
| Eugenol | 10.00 | 10.00 | 20.00 | 20.00 |
| Tween-80 | 6.25 | 11.25 | 12.50 | 7.50 |
| Water | 70.00 | 65.00 | 40.00 | 45.00 |

### Example 9

### Biocidal Effect of Oil/Water Emulsion Containing Terpene in Organic-Preservative-Free Apple Juice

To 100 ml of unpasteurized apple juice was added different concentration of A-70 formulation (as described on Example 8). After mixing, 0.1 ml of 1.20×10⁶ cfu E. coli was added and incubated at 37° C. overnight. After incubation 0.1 ml of the solutions was plated onto VRBG agar and incubated for 18 hours at 37° C. Results are expressed as cfu/ml and percent reduction as compared to positive control (control+E. coli).

TABLE 10
Biocidal effect of terpene compositions in organic
preservative-free apple juice.

| | | % |
|---|---|---|
| Treatment | cfu/ml | reduction |
| Control no E. coli | 0 | 0 |
| Control + E. coli | 1.4 × 10³ | 0 |
| 200 ppm + E. coli | 0 | 100 |
| 100 ppm + E. coli | 0 | 100 |
| 50 ppm + E. coli | 3.1 × 10² | 78 |
| 25 ppm + E. coli | 3.0 × 10² | 79 |
| 12.5 ppm + E. coli | 7.5 × 10² | 47 |
| 6.25 ppm + E. coli | 8.9 × 10² | 37 |

### Example 10

This example shows the spray application of the o/w emulsion prepared as in example 8 to poultry feed. Two kilograms of poultry feed was added to a mixer and sprayed with 2 ml of A-70 (example 8) while mixing for 5 minutes (application rate 1 liter/Metric Ton). The same procedure was follows for all other formulations (A-65, A-40 and A-45). One ml of water was added to a two kilogram feed and used as control feed.

### Example 11

This example shows the recovery of the o/w emulsion from example 10 when applied to feed. Twenty five grams of feed was extracted with 25 ml propanol, mixed and filtered through a 2.3 um glass filter for GC quantification. Quantification was done using a GC method with oven, injector and detector temperature at 160° C.

TABLE 11
Recovery of o/w emulsion on feed

| | % recovery of o/w emulsion | | | | |
|---|---|---|---|---|---|
| | Control | A-40 | A-45 | A-65 | A-70 |
| Week 1 | 0 | 77 | 84 | 45 | 55 |
| Week 3 | 0 | 35 | 42 | 76 | 61 |
| Week 6 | 0 | 46 | 46 | 0 | 0 |

### Example 12

This example shows the effect of unchallenged feed as described in example 10 on bacterial count. Ten grams of treated or untreated feed was added to 90 ml Butterfield buffer, mixed and 0.1 ml plated in nutrient agar. Plates were incubated overnight at 37° C. and visually counted after incubation.

TABLE 12
Bacterial load in treated feed

| | | % reduction |
|---|---|---|
| Treatment | cfu/gr feed | over control |
| Control | 1.1 × 10⁵ | 0% |
| A-40 | 5 × 10⁴ | 55% |
| A-45 | 8 × 10⁴ | 27% |
| A-65 | 2.0 × 10⁵ | 0% |
| A-70 | 1 × 10⁴ | 90% |

It will be apparent for those skilled in the art that a number of modifications and variations may be made in the present invention without departing from the scope of the invention. It is intended that the specification and examples be considered as exemplary only, with a true scope and spirit of the invention being indicated by the following claims.

1. A method for preserving water, feed and major feed ingredients for animal uses by the addition of a composition comprising a terpene or a mixture of terpenes, said composition comprising a surfactant or a surfactant with a carrier i.e. water.

2. The method of claim 1, wherein the terpene or terpene mixture are natural or synthetic terpenes selected from citral, b-ionone, eugenol and 1-carvone; and the surfactant is selected from polysorbate-80, polysorbate-20, polysorbate-40, polysorbate-60, polyglyceryl esters, polyglyceryl monooleate, decaglyceryl monocaprylate, propylene glycol dicaprilate and triglycerol monostearate or a combination thereof.

3. The method of claim 1, wherein the composition comprises about 1 to 99% terpenes, 0 to 50% surfactant and 0 to 99% water.

4. The method of claim 1, wherein the composition is done at a solution-forming shear until formation of a true solution of the terpene and surfactant.

5. The method of claim 1, wherein the composition is done at a solution-forming shear until formation of a composition of the terpene, surfactant and water.

6. The method of claim 4, wherein the solution-forming shear mixing is via a static mixer.

7. The method of claim 5, wherein the solution-forming shear mixing is via a static mixer.

8. The method of claim 4, wherein the composition is true solution.

9. The method of claim 5, wherein the composition is an oil/water emulsion.

10. The method of claim 1, wherein the composition is sprayed onto feed or a major feed ingredient while mixing said feed or major feed ingredient in a mixer facilitating uniform distribution of said composition.

11. The method of claim 1, wherein the composition is added to feed or major feed ingredient by a method that facilitates uniform distribution of said composition.

12. The method of claim 1, wherein the composition is added to water by means that allows uniform distribution of said composition.

13. The method of claim 1, wherein the concentration of the composition in water, feed and major feed ingredient comprises about 50 ppm to 10000 ppm, preferably 100 ppm to 1000 ppm.

14. The method of claim 1, wherein the composition is effective against pathogenic, normal and opportunistic microorganisms present in feed, major feed ingredients and water.

15. The method of claim 1, wherein animals comprise poultry i.e. chickens, turkeys, ducks, pheasants, pigeon, quail and other domestic birds.

16. The method of claim 1, wherein the animals comprise porcine, bovine, equine, ovine, caprine.

17. The method of claim 1, wherein the animals comprise pre-ruminants such as calves and other pre-ruminants.

18. The method of claim 1, wherein the animals comprise companion animals.

19. The method of claim 21, wherein companion animals are canine and feline.

20. The method of claim 21, wherein companion animals comprise other companion animals i.e. tropical birds, rabbits and small rodents (guinea pigs, hamsters, gerbils).
